(19) United States
(12) Patent Application Publication
(10) Pub. No.: US 2021/0216810 A1
(43) Pub. Date: Jul. 15, 2021

(54) MULTIPLE IMAGE SEARCH

(71) Applicant: Lenovo (Singapore) Pte. Ltd., Singapore (SG)

(72) Inventors: Nathan J. Peterson, Oxford, NC (US); Russell Speight VanBlon, Raleigh, NC (US); Mark Patrick Delaney, Raleigh, NC (US); Arnold S. Weksler, Raleigh, NC (US); John C. Mese, Cary, NC (US)

(21) Appl. No.: 16/738,744

(22) Filed: Jan. 9, 2020

(51) Int. Cl. G06K 9/62

(52) U.S. Cl. CPC G06K 9/6215; G06K 2209/27

(57) ABSTRACT

An approach is provided that receiving a set of images. Each of the received images was taken at an unknown location. Features from the set of images are compared to features found in a second set of images, where the second set of images were each taken at a known location. The comparison results in a location that is common to the set of images that were received. This resulting location is then associated with each of the images in the received set of images.

### BACKGROUND

When a group of images, such as a set of old photographs, is found, many online sites provide services to upload such images and post for public or private viewing, such as on a social media account. Many times, such a set of images might be from a particular place that is not readily apparent from the images themselves, such as a family vacation that was taken many years ago. Traditional services might identify a particular landmark in a single image, such as an image of the Eiffel Tower indicating to such service that the image was taken in Paris. However, such image services are challenged to extrapolate location data based on a culmination of several images where none of the images on their own discern the location of the set of images.

### SUMMARY

An approach is provided that receiving a set of images. Each of the received images was taken at an unknown location. Features from the set of images are compared to features found in a second set of images, where the second set of images were each taken at a known location. The comparison results in a location that is common to the set of images that were received. This resulting location is then associated with each of the images in the received set of images.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting the components used in performing a location analysis using multiple images as input;

FIG. 4 is a flowchart showing steps taken by a process that learns about location metadata by searching and retaining location metadata pertaining to images with known location origins; and

FIG. 5 is a flowchart showing steps taken by a process that identifies a location from a set of images where the location is unknown, using the location data learned in FIG. 4.

### DETAILED DESCRIPTION

The figures show an approach that analyzes multiple images and, from such analysis, discerns the location where the images were taken. Many people have, or inherit, old photographs from relatives or the like, or might even have digital images that were taken many years ago. Many times, individuals have difficulty remembering where these older photographs and images were taken. One image may not have enough unique data to clearly decide where the photo was taken. Using the approach, a user uploads two or more images (older photographs having been scanned and converted to digital images). The approach analyzes the images to further refine possibilities on a location where the images were taken. The approach may be able to provide a specific destination, such as indicate the “Asheboro Zoo” based upon images taken within a zoo. If the images were taken over a larger area, such as on a vacation to a particular region or city, the approach might provide an analysis result revealing such larger area, such as “Images are from Ashville, N.C.” The approach can also look at details in the images, such as clothing people are wearing between images, to provide a degree of certainty as to whether the photos were taken on the same day, and the like. The approach can also look at consistencies, such as the same people being in the images, etc. to ascertain whether a set of images is more closely related.

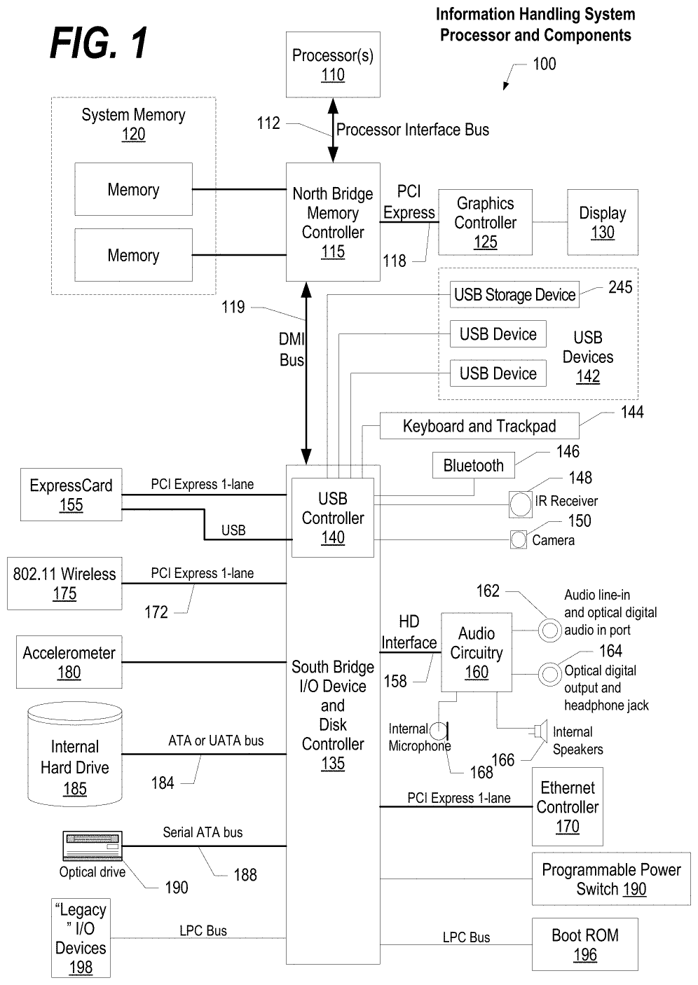

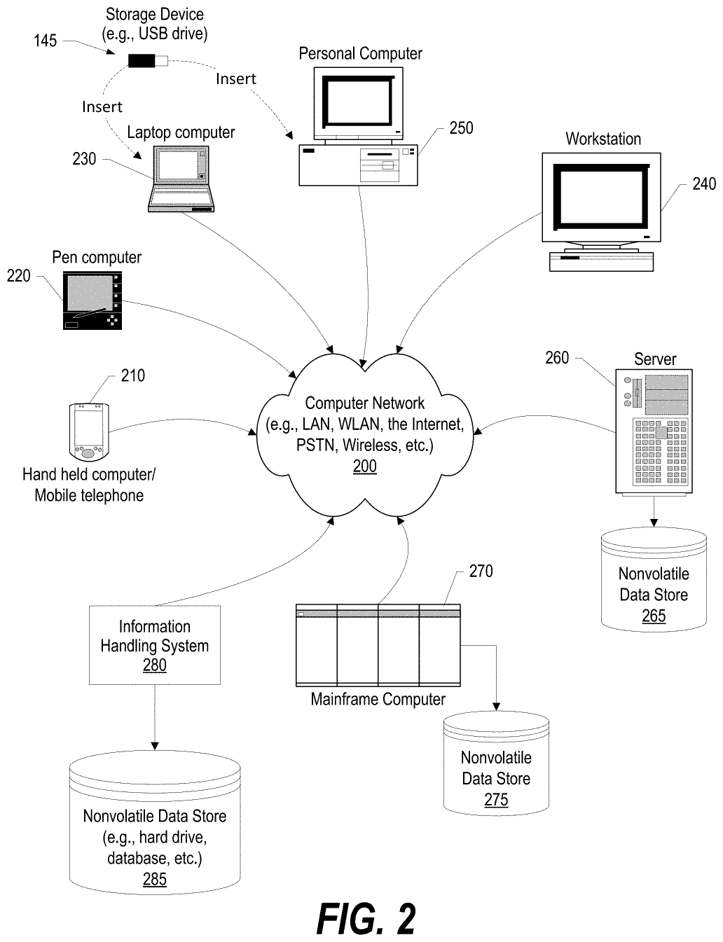

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a device that is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Accelerometer 180 connects to Southbridge 135 and measures the acceleration, or movement, of the device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may be a device that can take many forms. For example, an information handling system may take the form of a desktop device, server device, portable device, laptop device, notebook device, or other form factor device. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of devices that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling system devices include pen, or tablet, device 220, laptop, or notebook, device 230, workstation device 240, personal computer system device 250, and server device 260. Other types of information handling system devices that are not individually shown in FIG. 2 are represented by information handling system device 280. As shown, the various information handling system devices can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

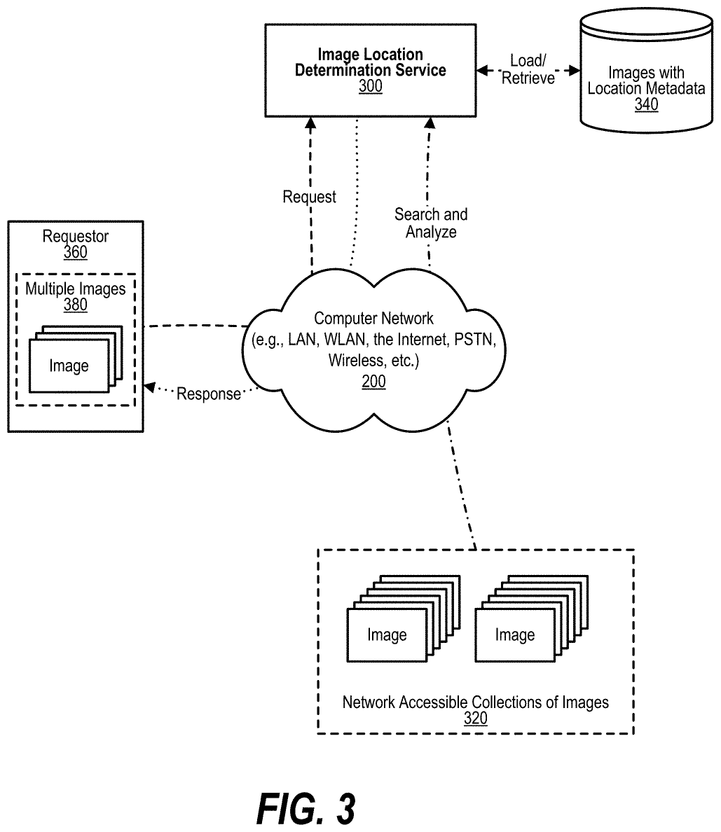

FIG. 3 is a component diagram depicting the components used in performing a location analysis using multiple images as input. Image Location Determination Service 300 is a service used to determine a location common to a set of images. The service operates by ingesting a large quantity of images that have known locations from network accessible collections of images 320, as might be found in online encyclopedias, websites pertaining to particular locations (e.g., continents, countries, regions, cities, towns, points of interest, and the like). Computer network 200, such as the Internet, is used to interconnect the service with network accessible collections of images 320 as well as with users 360 that request the service. The ingestion of the network accessible collections of images results in image location metadata that is stored in data store 340 that is maintained and used by service 300.

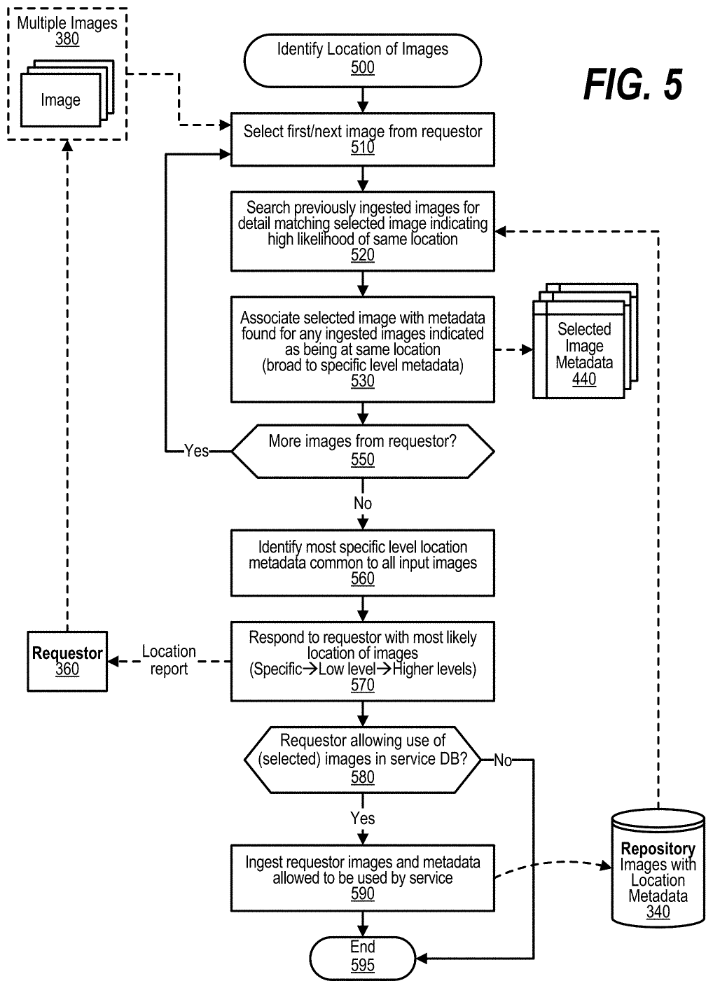

Requestor 360 is a user of the service and has a set of images 380 that are from one location (e.g., taken during a vacation years ago, etc.). Requestor 360 submits the set of images 380 to service 300. Service 300 uses the process shown in FIG. 5 to analyze the images received from the user by comparing features included in images that are part of the set of images with features found in previously ingested images that had known locations. For example, one of the images in the user's set of images might have a feature being a unique castle turret that is identified as being part of a castle near a town in France, while another image is from a small café that is identified as formerly being at the same town. Using this information, service 300 informs the user of the location that is common to the set of images, in this case the location being a particular town in France and its outlying areas.

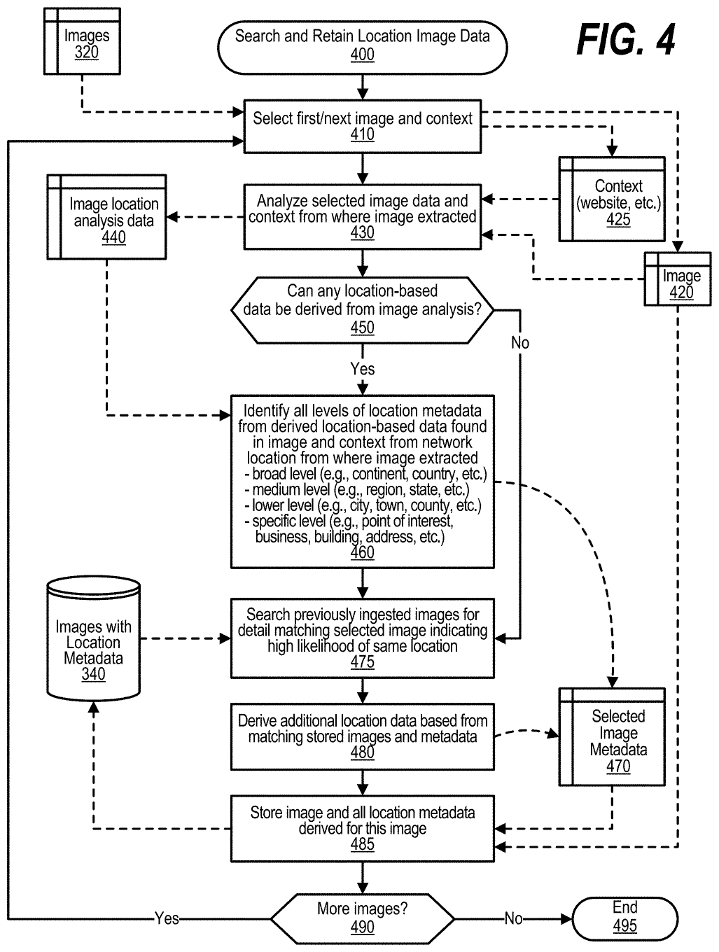

FIG. 4 is a flowchart showing steps taken by a process that learns about location metadata by searching and retaining location metadata pertaining to images with known location origins. FIG. 4 processing commences at 400 and shows the steps taken by a process that ingests data by searching for network accessible images with known locations and storing the identified image data and corresponding metadata for future use by the service. At step 410, the process selects the first image and its context from network accessible image repository 320, such as an online encyclopedia, website, etc. The image data is retained in memory area 420 while the contextual data is retained in memory area 425.

At step 430, the process analyzes the selected image data and its context from the network location (e.g., encyclopedia entry, website, etc.) from where the selected image was extracted. The analysis of the image location performed by step 430 is stored in memory area 440. The process determines whether any location-based data can be derived from the image analysis (decision 450). For example, the image data might include a feature that is a sign, banner, or other textual material that can be identified and processed for further location data, and the contextual data might indicate that the image was extracted from a website pertaining to a particular point of interest that is located in a particular location (continent, country, state/province, city, etc.).

If any location-based data can be derived from the image analysis, then decision 450 branches to the ‘yes’ branch whereupon, at step 460, the process identifies all levels of location metadata that are derived from the location-based data found in the image and the context pertaining to the image from the image's network location where image was found. In one embodiment, different levels of location metadata are identified such as broad level location metadata (e.g., continent, country, etc.), medium level location metadata, (e.g., region, state, etc.), lower level location metadata (e.g., city, town, county, etc.), and specific level location metadata (e.g., point of interest, business, building, address, etc.). The identified metadata (all levels of metadata) are stored in memory area 470 as location metadata pertaining to the selected image. Returning to decision 450, if no location-based data be derived from the image analysis performed by step 430, then decision 450 branches to the ‘no’ branch bypassing step 460.

At step 475, the process searches through previously ingested images found in data store 380 for images features (details) that match features from the selected image with these matching features indicating a high likelihood that the images were taken at the same location. At step 480, the process derives additional location based metadata from the matching of stored features with features from the selected image features. These derived additional location metadata are also stored in memory area 470 as additional metadata pertaining to the selected image. At step 485, the process stores the selected image and all of the location metadata identified and otherwise derived for the selected image into data store 340 which serves as a repository of image data for the location identifying service.

The process determines as to whether there are more network-accessible images to select, process, and store in the service's repository (decision 490). If there are more network-accessible images to select, process, and store in the service's repository, then decision 490 branches to the ‘yes’ branch which loops back to step 410 to select and process the next image as described above. This looping continues until there no are more network-accessible images to select, process, and store in the service's repository, at which point decision 490 branches to the ‘no’ branch exiting the loop. FIG. 4 processing thereafter ends at 495.

FIG. 5 is a flowchart showing steps taken by a process that identifies a location from a set of images where the location is unknown, using the location data learned in FIG. 4. FIG. 5 processing commences at 500 and shows the steps taken by a process that identifies a location of a set images that were taken at an otherwise unknown location. At step 510, the process selects the first image from the set of images 380 that was received from user (requestor) 360.

At step 520, the process searches previously ingested images stored in repository 340 for features matching features found in the selected image with such matching indicating a high likelihood that the images were taken in the same location. In one embodiment, a confidence value is included in the search indicated the level of confidence the system has that the selected image and the image from the repository are from the same location.

At step 530, the process associates selected image with the metadata that was previously found for any ingested images stored in repository 340 that indicate that the selected image was taken at the same location as one or more images from the repository. In one embodiment, broad to specific level metadata is identified with confidence levels corresponding to how likely each level of metadata correctly matches the selected image that was included in the user's request.

The process determines as to whether there are more images that were included in the set of images received from the user (decision 550). If there are more images that were included in the set of images received from the user, then decision 550 branches to the ‘yes’ branch which loops back to step 510 to select and process the next image from the set of images received from the user as described above. This looping continues until all of the images received from the user have been processed, at which point decision 550 branches to the ‘no’ branch exiting the loop.

At step 560, the process identifies the most specific level of location metadata that is common to all or substantially large percentage of the images included in the set of images received from the user. At step 570, the process responds to user 360 with the most likely location of images. In one embodiment, confidence values are included with multiple geographic scopes being provided to the user. For example, there might be a low percentage of likelihood that substantially all of the images were taken at a point of interest outside of a town in France, a higher percentage of likelihood that substantially all of the images were taken at a particular town in France and its outlying areas, an even higher percentage of likelihood that substantially all of the images were taken in the country of France, and an even higher percentage of likelihood that substantially all of the images were taken in the continent of Europe.

The process next determines whether the user has allowed the service to use one or more (selected) images received from the user in the repository that is used by the service (decision 580). If the user has allowed the service to use one or more (selected) images received from the user in the repository, then decision 580 branches to the ‘yes’ branch, whereupon at step 590, the process ingests the selected images received from and allowed by the user and such images' corresponding metadata into repository 340. On the other hand, if the user has not allowed the service to use any of the images received from the user, then decision 580 branches to the ‘no’ branch bypassing step 590. FIG. 5 processing thereafter ends at 595.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

What is claimed is:

1. A method, implemented by an information handling system comprising a processor, a memory accessible by the processor, and a network interface connecting the information handling system to a computer network, the method comprising:
receiving a set of images, wherein each of the set of images were taken at an unknown location;
comparing a first plurality of features from a first plurality of the set of images to a second plurality of features from a second plurality of images, wherein each of the second plurality of images corresponds to a known location, wherein the comparing results in a location that is common to the set of images; and
associating the resulting location with each of the set of images.

2. The method of claim 1 further comprising:
receiving the set of images from a user; and
responding to the user with the location found to be common to the set of images.

3. The method of claim 1 further comprising:
after associating the resulting location with each of the set of images, including one or more images from the first plurality of the set of images in the second plurality of images, wherein the second plurality of images is a repository of publicly accessible images.

4. The method of claim 3 further comprising:
receiving the set of images from a user; and
receiving a permission from the user to include the one or more images in the repository of publicly accessible images.

5. The method of claim 1 further comprising:
associating one or more specificities of location data with each of the first plurality of the set of images; and
analyzing the associated specificities of location data to ascertain the location common to the set of images.

6. The method of claim 1 further comprising:
receiving the set of images from a user; and
responding to the user with the location found to be common to the set of images and the associated specificities of location data corresponding to each of the first plurality of the set of images.

7. The method of claim 6 wherein the location common to the set of images includes a plurality of possible locations at different geographic scopes, wherein each of the possible locations corresponds to a first confidence level, and wherein the associated specificities of location data also correspond to a second confidence level.

8. An information handling system comprising:
one or more processors;
a memory coupled to at least one of the processors;
a network interface that connects the information handling system to a computer network; and
a set of computer program instructions stored in the memory and executed by at least one of the processors in order to perform actions comprising:
receiving a set of images, wherein each of the set of images were taken at an unknown location;
comparing a first plurality of features from a first plurality of the set of images to a second plurality of features from a second plurality of images, wherein each of the second plurality of images corresponds to a known location, wherein the comparing results in a location that is common to the set of images; and
associating the resulting location with each of the set of images.

9. The information handling system of claim 8 wherein the actions further comprise:
receiving the set of images from a user; and
responding to the user with the location found to be common to the set of images.

10. The information handling system of claim 8 wherein the actions further comprise:
after associating the resulting location with each of the set of images, including one or more images from the first plurality of the set of images in the second plurality of images, wherein the second plurality of images is a repository of publicly accessible images.

11. The information handling system of claim 10 wherein the actions further comprise:
receiving the set of images from a user; and
receiving a permission from the user to include the one or more images in the repository of publicly accessible images.

12. The information handling system of claim 8 wherein the actions further comprise:
associating one or more specificities of location data with each of the first plurality of the set of images; and
analyzing the associated specificities of location data to ascertain the location common to the set of images.

13. The information handling system of claim 8 wherein the actions further comprise:
receiving the set of images from a user; and
responding to the user with the location found to be common to the set of images and the associated specificities of location data corresponding to each of the first plurality of the set of images.

14. The information handling system of claim 13 wherein the location common to the set of images includes a plurality of possible locations at different geographic scopes, wherein each of the possible locations corresponds to a first confidence level, and wherein the associated specificities of location data also correspond to a second confidence level.

15. A computer program product comprising:
a computer readable storage medium, comprising computer program code that, when executed by an information handling system, executes actions comprising:
receiving a set of images, wherein each of the set of images were taken at an unknown location;
comparing a first plurality of features from a first plurality of the set of images to a second plurality of features from a second plurality of images, wherein each of the second plurality of images corresponds to a known location, wherein the comparing results in a location that is common to the set of images; and
associating the resulting location with each of the set of images.

16. The computer program product of claim 15 wherein the actions further comprise:
receiving the set of images from a user; and
responding to the user with the location found to be common to the set of images.

17. The computer program product of claim 15 wherein the actions further comprise:
after associating the resulting location with each of the set of images, including one or more images from the first plurality of the set of images in the second plurality of images, wherein the second plurality of images is a repository of publicly accessible images.

18. The computer program product of claim 7 wherein the actions further comprise:
receiving the set of images from a user; and
receiving a permission from the user to include the one or more images in the repository of publicly accessible images.

19. The computer program product of claim 15 wherein the actions further comprise:
associating one or more specificities of location data with each of the first plurality of the set of images; and
analyzing the associated specificities of location data to ascertain the location common to the set of images.

20. The computer program product of claim 15 wherein the actions further comprise:
receiving the set of images from a user; and
responding to the user with the location found to be common to the set of images and the associated specificities of location data corresponding to each of the first plurality of the set of images.
